(19) United States
(12) Patent Application Publication
(10) Pub. No.: US 2026/0235743 A1
(43) Pub. Date: Aug. 13, 2026

(54) Method and Apparatus for Providing Training Data Sets for the Training of a Classification Model for Object Identification for an Ultrasonic Sensor System in a Mobile Device

(71) Applicant: Robert Bosch GmbH, Stuttgart (DE)

(72) Inventors: Tom Reimann, Bissingen An Der Teck (DE); Thomas Geiler, Aidlingen (DE); Michael Tchorzewski, Boeblingen (DE)

(21) Appl. No.: 19/156,728

(22) PCT Filed: Feb. 7, 2024
(86) PCT No.: PCT/EP2024/053034

§ 371 Date: Aug. 14, 2025

(30) Foreign Application Priority Data
Feb. 16, 2023 (DE) 10 2023 201 328.2

(51) Int. Cl. G01S 7/52; G01S 7/539

(52) U.S. Cl. CPC G01S 7/52004; G01S 7/539

(57) ABSTRACT

A method is for training a data-based classification model for a configuration of a new ultrasonic sensor system including a plurality of ultrasonic transducers using training data sets. The classification model specifies, for one or more environmental objects, at least one class for an object property. A training data set assigns an input data set from sensor data of the ultrasonic transducer and/or from sensor data features derived therefrom to a classification vector for one or more environmental objects. The method includes providing training data sets and validation data sets for multiple configurations of measured ultrasonic sensor systems. The training data sets and the validation data sets each include, for a measurement situation of a measurement with the relevant configuration, an input data set from sensor data of the ultrasonic transducers and/or from sensor data characteristics derived therefrom to a classification vector for one or more environmental objects.

### TECHNICAL FIELD

The invention relates to ultrasonic sensor systems for mobile devices, such as motor vehicles, and in particular to methods for providing training data sets for training a classification model for object classification based on input data sets corresponding to and/or derived from ultrasonic transducer data.

### TECHNICAL BACKGROUND

Vehicles are typically equipped with ultrasonic sensor systems for object detection. These often have multiple ultrasonic transducers for different detection ranges in which environmental objects are to be detected. Such an ultrasonic sensor system is often arranged on the front and/or rear bumper of a vehicle.

In addition to locating environmental objects by evaluating the sensor data from the ultrasonic transducers, the sensor data may also be used to classify the environmental objects. In particular, a classification should make it possible to differentiate between the height of environmental objects, in particular with respect to whether the environmental objects are traversable or non-traversable by the mobile device, i.e., whether they are conflict-relevant.

The classification of environmental objects is typically done using classification models. These may be data-based, i.e., the classification model may be trained using a machine learning method using training data sets.

Ultrasonic sensor systems may differ between different types of vehicles in terms of configuration, i.e., in terms of the number, arrangement and types of ultrasonic transducers used, such that training data sets for the classification model of an ultrasonic sensor system may not readily be used for training a classification model in an ultrasonic sensor system having a different configuration. However, capturing training data sets for new configurations for ultrasonic sensor systems is complex and represents a significant amount of time prior to commissioning the ultrasonic sensor system.

### DISCLOSURE OF THE INVENTION

According to the present invention, there are provided a method for providing training data sets for training a classification model for a new configuration of an ultrasonic sensor system for a mobile device according to claim 1 as well as an apparatus and method of classification for object identification using an ultrasonic sensor system in a mobile device.

Further embodiments are specified in the dependent claims.

According to a first aspect, a method is provided, in particular computer-implemented method, for training a data-based classification model for a configuration of a new ultrasonic sensor system comprising a plurality of ultrasonic transducers using training data sets, wherein the classification model specifies, for one or more environmental objects, at least one class for an object property, wherein a training data set assigns an input data set from sensor data of the ultrasonic transducers and/or from sensor data features derived therefrom to a classification vector for one or more environmental objects, the method comprising the following steps:
providing training data sets and validation data sets for multiple configurations of measured ultrasonic sensor systems, wherein the training data sets and the validation data sets each comprise, for a measurement situation of a measurement with the relevant configuration, an input data set from sensor data of the ultrasonic transducers and/or from sensor data characteristics derived therefrom to a classification vector for one or more environmental objects,
selecting one or more measured ultrasonic sensor systems, each depending on a sensor comparison metric for the difference between the configuration of the new ultrasonic sensor system and the configuration of the measured respective measured ultrasonic sensor system, wherein the respective sensor comparison metric is determined from the differences in configuration features of the respective configuration of the new ultrasonic sensor system and the respective measured ultrasonic sensor system in accordance with a comparison metric model provided, which evaluates the comparability of two configurations of ultrasonic sensor systems depending on differences in the configuration features of the configurations under consideration,
selecting training data sets and validation data sets that are assigned to the selected measured ultrasonic sensor systems;
training the classification model for the configuration of the new ultrasonic sensor system on the basis of the selected training data sets and the validation data sets.

In utilizing data-based classification models for object identification with ultrasonic sensor systems, one difficulty is to obtain sufficient training data sets. The training data sets are typically determined by recording sensor signals for different environmental situations. To do this, the environmental situations must be created and a measurement performed using the ultrasonic sensor system for which a classification model is to be created. The data-based classification model may comprise a neural network, a probabilistic regression model, a decision tree trained using a gradient boosting algorithm, or the like.

Each of the measurement situations intended for creating a training data set can be determined, for example, by one or more environmental objects, each with the same or different object properties, such as heights, widths, and the like, and each with the same or different distances and/or orientations relative to the ultrasonic sensor system.

The training data sets determined from different measurement situations each provide an input data set comprising the sensor data and/or sensor data characteristics aggregated from the sensor data, such as a maximum signal amplitude, a histogram of the number of multiple runners with respect to the detections of the detected environmental object, a proportion of point/line/single echo detections of the ambient object, a proportion of detections with certain signal patterns, e.g., signal patterns indicating pedestrians, with respect to amplitude, multiple reflections and the like, an average number of ultrasonic transducers that detect a certain ambient object.

The environmental object to be classified is classified accordingly, and a classification vector is provided as a label that each comprises a plurality of object classes for the one or more environmental objects, each indicating the presence (or a model reliability of the presence) of a particular predefined object property. The classification vector forms the label for the corresponding training data set assigned to the measurement situation.

For a particular measurement situation, the input data sets of the training data sets will depend significantly on the configuration of the ultrasonic sensor system in question. The configuration of the ultrasonic sensor system results from configuration features indicative of the number and arrangement, and, if applicable, types of ultrasonic transducers used, and the like. In particular, the arrangement can be specified by the following features: one or more interference measures of the detection ranges between two specific adjacent ultrasonic transducers of the ultrasonic sensor system in question, an installation height of one or more of the ultrasonic transducers, and a detection angle of the detection range of one or more of the ultrasonic transducers. In addition, the features can determine the vertical installation angle of the ultrasonic transducers (e.g., relative to a sensor center axis), the offset of the respective installation heights of the ultrasonic transducers, and the horizontal installation angles of the ultrasonic transducers (e.g., relative to a sensor center axis).

It may be provided that further training data sets and further validation data sets are obtained for the configuration of the new ultrasonic sensor system by measurement, wherein the classification model is trained with the selected training data sets and the selected validation data sets and the further training data sets and further validation data sets. The above method provides for training data sets for training the corresponding classification model for a new configuration of a new ultrasonic sensor system by using training data sets already captured for other configurations of ultrasonic sensor systems and, if necessary, validation data sets, even though these were determined for a different configuration of an ultrasonic sensor system.

The method is based on training data sets and validation data sets captured for several different configurations of ultrasonic sensor systems. The training data sets relate to different measurement situations with the relevant configuration of the ultrasonic sensor system, wherein different distances of the environmental object from the ultrasonic sensor system are taken into account.

To determine which training data sets and validation data sets from previously measured ultrasonic sensor systems can be used for the new ultrasonic sensor system, a sensor comparison metric is provided in accordance with the above method. The sensor comparison metric helps to configure the new ultrasonic sensor system by finding the ultrasonic sensor system or systems that have already been measured and whose configurations exhibit comparable behavior with regard to the ultrasonic data to be evaluated.

A data-based or parametric comparison metric model is used to utilize the sensor comparison metric. This comparison metrics model is trained to evaluate the comparability between two configurations of ultrasonic sensor systems.

The comparison metric model can be data-based and determine a sensor comparison metric depending on a configuration feature difference vector. The configuration feature difference vector results from the respective differences between the configuration features of two considered configurations of ultrasonic sensor systems. Such a comparison metric model can map such a configuration feature difference vector to a difference in performance comparison measures of the configurations of the two ultrasonic sensor systems in question. The comparison metric model can now be trained or parameterized with corresponding training data from the configuration feature difference vector and the difference in performance comparison measures.

In the following, the comparison metric model determined in this way can be used to evaluate a configuration of a new ultrasonic sensor system in relation to a configuration of an ultrasonic sensor system that has already been measured. In this way, a sensor comparison metric is determined that shows how similar the configurations of the ultrasonic sensor systems compared with each other are or how similar the configurations of the ultrasonic sensor systems compared with each other affect the measurement data.

The performance comparison measures can be determined in a variety of ways. In particular, the determination of the performance comparison measures is based on the evaluation of training data sets of a configuration of a first ultrasonic sensor system with the validation data sets of a configuration of a second ultrasonic sensor system. Thus, for two compared configurations of ultrasonic sensor systems, a corresponding performance comparison measure can be determined for each of the configurations with respect to the validation data of the corresponding other configuration. The above comparison metric model can then be trained on the difference between the performance comparison measures determined in this way as a sensor comparison metric based on the corresponding configuration feature difference vector.

For example, to determine the performance comparison metrics, it may be provided that a classification model is provided for each of the measured ultrasonic sensor systems in question, which is trained with the respective associated training data sets and validation data sets. Training can be performed based on the correspondingly assigned validation data sets and the resulting classification model can be validated accordingly.

The performance comparison metric for one of the measured ultrasonic sensor systems in question is then obtained from a validation of the measured ultrasonic sensor system in question with the validation data of the corresponding other of the two measured ultrasonic sensor systems.

The validation data sets may each comprise measurement situations with variable distances between one or more environmental objects to be classified, wherein the performance comparison measure is determined as a function of a minimum distance between the one or more environmental objects to be classified and the ultrasonic sensor system, which is determined as the smallest distance at which proper classification is performed by the relevant classification model of one of the relevant measuring ultrasonic sensor systems when using the validation data sets of the relevant other of the measured ultrasonic sensor systems.

The validation data should be comparable for the configurations of the measured ultrasonic sensor systems, especially with regard to the test objects and environmental conditions used (temperature, ground noise . . . ).

The sensitivity of the model performance with regard to the installation position also depends on the object class (post, wall, vehicle) being considered. If there are enough training data sets for measurement situations, it also makes sense to define the sensor comparison metric separately for each object class. Each configuration for different environmental objects would then be considered separately in the above method.

Loading changes important attributes of the configuration of an ultrasonic sensor system, such as installation height or vertical angle. Two configurations are therefore usually defined for each vehicle variant for an unloaded and a maximum loaded state. With the comparison metric model, the sensor comparison metric can now be predicted as the performance difference between these states in the case that only one classification model is used. Furthermore, a configuration can also be determined that minimizes the performance loss for both configurations (unloaded and maximum loaded state) and this can then be used for model training.

Furthermore, the classification model may be re-trained with further training data sets for the configuration of the new ultrasonic sensor system.

Alternatively, the above method can also be used in a sensor network in which the ultrasonic sensor system is integrated with other sensor systems, such as video sensors, radar sensors or the like. The method then makes it possible to improve data acquisition for the ultrasonic sensor system.

According to a further aspect, provided is an apparatus for carrying out the above method.

### BRIEF DESCRIPTION OF THE DRAWINGS

Preferred embodiments are described in more detail below with reference to the accompanying drawings. The figures show:

FIG. 1 a schematic illustration of a vehicle having an ultrasonic sensor system having a configuration of ultrasonic transducers;

FIG. 2 a flowchart illustrating a method for determining training data sets for training the classification model for object identification in the ultrasonic sensor system; and

FIG. 3 a schematic illustration of an exemplary configuration of ultrasonic wandering of an ultrasonic sensor system on a vehicle

FIG. 4 a flowchart illustrating a method for creating a comparison metric model

FIG. 5 an exemplary representation of a possible weighting function for determining the performance comparison metric.

### DESCRIPTION OF EMBODIMENTS

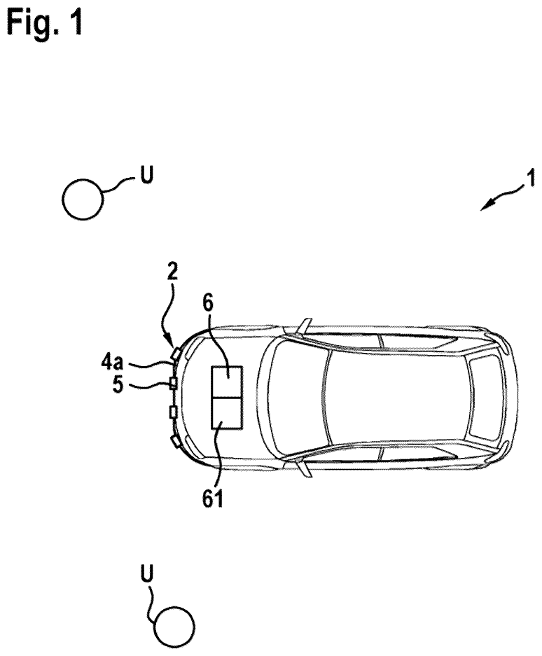

FIG. 1 shows a schematic representation of a vehicle 1 in the vehicle surroundings, in which one or multiple environmental objects U can be located. The vehicle 1, by way of example a mobile apparatus, comprises an ultrasonic sensor system 2 arranged on a bumper 4. The ultrasonic sensor system 2 comprises multiple ultrasonic transducers 5 for emitting an ultrasonic signal with signal pulses and for receiving ultrasonic signals reflected from the environmental objects U. The arrangement of the ultrasonic transducers 5 and the type of ultrasonic transducers 5 determine a configuration of the ultrasonic sensor system 2. Different types of vehicles 1 comprise different ultrasonic sensor systems 2 having different configurations.

A control unit 6 is provided, which is used to evaluate the sensor signals from the ultrasonic transducers 5 of the ultrasonic sensor system 2. In the control unit 6, a data-based classification model 61 is implemented in addition to a localization model for localizing the environmental objects relative to the vehicle 1. The data-based classification model may comprise a neural network, a probabilistic regression model, a data-based decision tree that can be trained using a gradient boosting algorithm, or the like. The sensor signals of the ultrasonic transducers 5 are evaluated in a known manner using ultrasound-based localization methods to create a virtual map of the surroundings in the control unit 6 and to enter the positions of detected environmental objects U there.

The classification model 61 is usually specially trained for the configuration of ultrasonic sensor system 2. Said model has or will be trained to perform a classification of environmental objects U with respect to an object property, in particular their height, primarily in order to distinguish whether the environmental object in question can or cannot be driven over by the vehicle 1, i.e. is collision-relevant. The classification model 61 is for this purpose trained to determine a classification result for each environmental object U, which assigns an object property to each environmental object U identified in the surroundings.

The detected environmental objects are assigned to classification results using the classification model 61. The classification results classify the environmental objects U according to the corresponding relevant object properties, in particular according to height classes.

The data-based classification model 61 assigns a classification vector to an input data set, which can comprise a signal time series of the sensor signals from the ultrasonic transducers and/or signal features derived or aggregated therefrom. The classification vector comprises elements that quantify a possible class of the classification result for each identified environmental object. The value of the element indicates the probability that object property assigned to the class is realized by the environmental object U relating to the class. Using a selection function, such as a sigmoid function, an argmax function, etc., of the elements of the classification vector assigned to a respective environmental object, the specific class can be output as the classification result for the model evaluation. The value of the element determined by the selection function corresponds to the classification confidence.

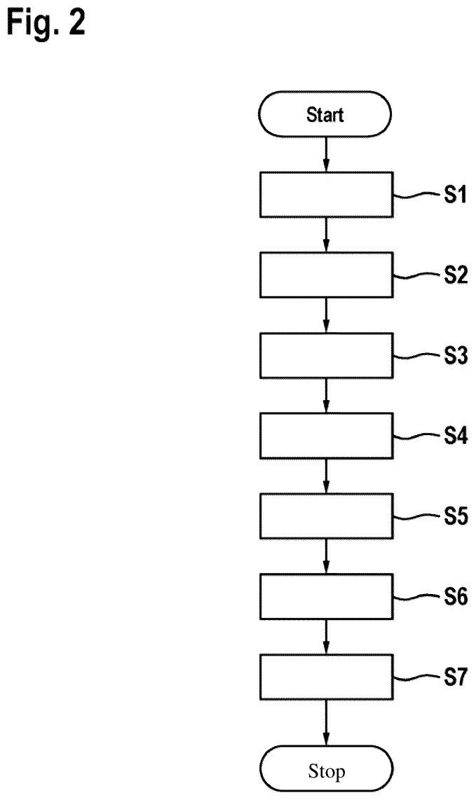

Up to now, when creating a data-based classification model 61 for a new configuration of an ultrasonic sensor system, training data sets have generally had to be identified in a time-consuming manner by measuring the measurement situations. For this purpose, measurement situations are simulated and corresponding signal time series of the sensor signals are recorded, input data sets are generated therefrom and these are assigned to a classification vector, which indicates the relevant object property of the environmental object, for example, in the form of a one-hot-coded vector, for each of the environmental objects provided in the measurement situation. In order to reduce the measurement effort, a method is described below in conjunction with the flowchart in FIG. 2 that makes it possible to derive associated training data sets and associated validation data sets (which have been created with these ultrasonic sensor systems) and use them to train the classification model for the configuration of the new ultrasonic sensor system.

The method in FIG. 2 can be implemented as software or hardware in a conventional data processing device and can in particular be performed offline, i.e., outside the vehicle in which the classification model 61 is intended to be used.

In step S1, a database is first provided in which two training data sets and validation data sets for different measurement situations are available for multiple configurations of ultrasonic sensor systems 2. A measurement situation is generally determined by measurement characteristics that specify the relative position of one or more environmental objects to the ultrasonic sensor system 2 or the distance from the ultrasonic sensor system and the associated orientation, as well as a property of the environmental object U, such as a height or height class of the one or more environmental objects U.

The different configurations of the ultrasonic sensor systems 2 are determined by characterizing configuration features, which may include, for example, arrangement features and sensor-type features. The arrangement features may comprise, for example, one or more of the following: an installation height of one or more of the ultrasonic transducers, a vertical installation angle of one or more of the ultrasonic transducers, an offset of the installation heights between the ultrasonic transducers, a horizontal installation angle of the ultrasonic transducers, one or more overlap dimensions of the detection ranges between two specific adjacent ultrasonic transducers, and a detection angle of the detection area of one or more of the ultrasonic transducers. Considering the sensor type in the sensor type feature may be particularly important, as ultrasonic transducer 5 may have different sensitivities and reception characteristics, such as detection angles.

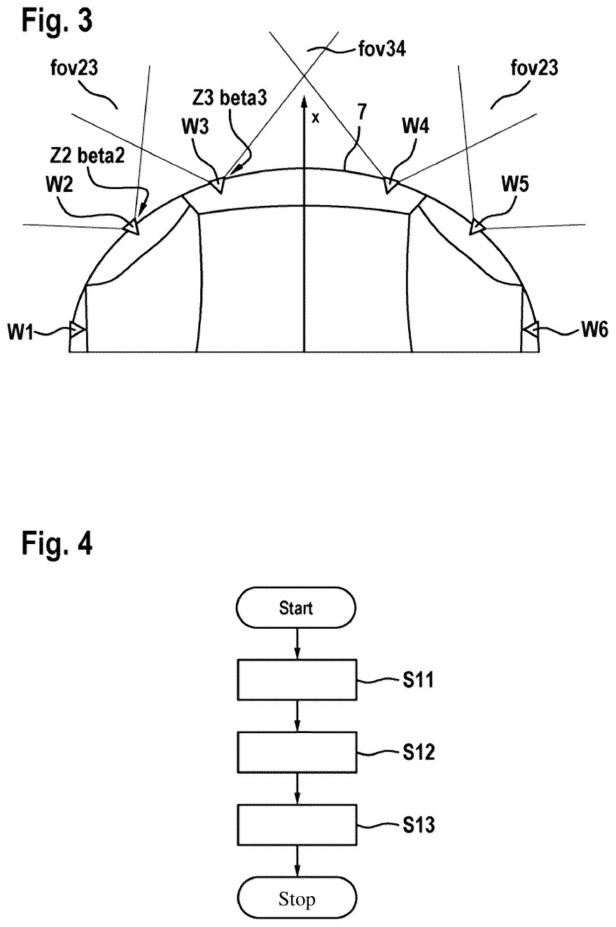

In step S2, a configuration of a new ultrasonic sensor system is provided for which training data sets are to be derived from other configurations of ultrasonic sensor systems that have already been measured. FIG. 3 shows an example of a configuration for a new ultrasonic sensor system with the ultrasonic transducers W1-W6 on a vehicle front 7. The ultrasonic transducers W1-W6 are arranged symmetrically with respect to a longitudinal axis X, so that configuration features only need to be specified for one side of the ultrasonic transducers.

In step S3, the corresponding configuration features for the configuration of the novel ultrasonic sensor system 2 are determined. For example, the following features can be taken into account as configuration features:
Dimension/proportion fov23 of the overlap of the detection ranges between ultrasonic transducers W2 and W3
Dimension/proportion fov34 of the overlap of the detection ranges between ultrasonic transducers W3 and W4
Installation height z2 of the ultrasonic transducer W2
Installation height z3 of the ultrasonic transducer W3
Vertical detection angle beta2 of the ultrasonic transducer W2
Vertical detection angle beta 3 of the ultrasonic transducer W3.

The overlap can be measured, for example, by the distance between the detection ranges of the ultrasonic transducers at a specified distance, such as 1 m, depending in particular on the horizontal alignment of the ultrasonic transducers and their distance from each other. This distance is inversely proportional to the overlap of the detection ranges.

A comparison metric model is provided in step S4. The comparison metric model evaluates the comparability of two configurations of ultrasonic sensor systems depending on differences in the configuration characteristics of the configurations under consideration. The comparative metric model can be data-based or designed as a parametric model. The comparison metric model can be used to determine a similarity between two considered configurations of ultrasonic sensor systems, which indicates a probability of whether the evaluation of sensor data leads to similar classification results or indicates the transferability of the training data sets.

In step S5, a sensor comparison metric is determined for all combinations between the configuration of the new ultrasonic sensor system and one of the configurations of the ultrasonic sensor systems already measured.

In step S6, the sensor comparison metrics sm are compared with a predetermined threshold value using a threshold value comparison in order to select the corresponding ultrasonic sensor system that has already been measured if the predetermined threshold value is exceeded or undershot.

In step S7, the training data sets of the configurations of the selected ultrasonic sensor systems are combined with any training data sets already collected for the configuration of the new ultrasonic sensor system and a corresponding data-based classification model is trained using the training data sets obtained in this way. Similarly, the validation data sets of the selected measured ultrasonic sensor systems can be used to validate the data-based classification model trained in this way.

FIG. 4 illustrates a method using a flowchart with which the comparison metric model can be created based on a plurality of measured ultrasonic sensor systems. This method can be carried out before the procedure for determining training data and training the classification model is carried out.

In step S11, corresponding classification models are first trained based on the assigned training data sets provided for all measured ultrasonic sensor systems. The training can be validated based on the validation data sets assigned to the corresponding measured ultrasonic sensor systems.

In step S12, performance metrics are determined for the trained classification models of the measured ultrasonic sensor systems. This is based on validation data sets for the configurations of the other ultrasonic sensor systems.

The performance metric p is a measure of the absolute performance of a particular classification model of a first configuration of an ultrasonic sensor system with respect to a second configuration of an ultrasonic sensor system. For this purpose, the applicability of the classification model of the first configuration is evaluated with regard to the validation data set for the second configuration. The performance metric p for a specific first configuration of an ultrasonic sensor system with respect to a configuration of a further (second) ultrasonic sensor system can be determined, for example, according to the following formula:

$$p = {\sum }_{j = 1}^{m} ( aj ( d ) * \frac{{\sum }_{i = 1}^{{n}_{j}} {d}_{{i}_{j}}}{{n}_{j}} )$$

wherein j represents in each case one of a number m of scenarios of the validation data sets which are assigned to the second configuration of an ultrasonic sensor system under consideration. dᵢⱼ represents the distance from which the environmental object of the scenario in question was continuously correctly classified during the measurement of scenario j. nⱼ corresponds to the number of measurement situations for the respective scenario j and aⱼ to a distance-dependent (distance of the environmental object in question) weighting factor of scenario j.

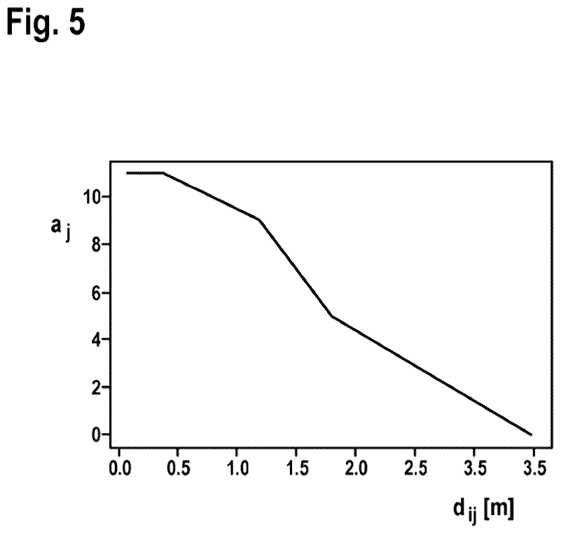

For aⱼ a linear weighting function can be selected, for example, as shown in FIG. 5.

The performance metric results in p=0 if the classification model for the further configuration of the ultrasonic sensor system or its validation data sets enables the best possible classification of environmental objects.

To determine a performance comparison metric for two validation data sets for two different configurations, the difference between the corresponding performance metrics Δp is calculated using Δp12=p1−p2.

In order to analyze the behavior of the performance metric, the classification models of all available configurations of the measured ultrasonic sensor systems are first optimized with the previously specified validation data sets for this particular configuration with regard to the performance metric.

These validation data sets should be comparable for the individual configurations with regard to the test objects and environmental conditions used (temperature, ground noise . . . ). Comparability here means that the underlying environmental objects are identical or similar in terms of position and movement, an approximately equal number of validation data are recorded per environmental object (difference<factor 10) and/or the distributions of the measurements with regard to metadata such as temperature and ground noise are similar, i.e. their standard deviations have a difference of less than 10-20%, for example.

All classification models are tested on all other validation data sets of the other configurations of the measured ultrasonic sensor systems and the performance metrics are determined. If you set an experience-based limit value for the performance metric that defines the acceptable performance loss when transferring models, you can specify a range for the configuration parameters for each configuration in which the respective configuration can be used with regard to the sensor configuration.

The performance metrics cannot be calculated for unknown ultrasonic sensor configurations for which no measurement has been carried out, as no trained classification model is yet available. In order to be able to predict the performance loss with regard to the training data sets of the other ultrasonic sensor systems, a comparison metric model is created in the following, which can predict the behavior of the performance metric depending on the configuration of the new ultrasonic sensor model.

The comparison metric model uses a sensor comparison metric sm for the configuration of the new ultrasonic sensor model and the respective configuration of an ultrasonic sensor system that has already been measured to evaluate the usability of the training data assigned to the operator of the measured ultrasonic sensor model in question for the configuration of the new ultrasonic sensor model. For this purpose, configuration feature difference vectors DV=(Δfov23, Δfov34, Δz2, Δz3, Δbeta2, Δbeta3) are determined. For a simpler representation of the equation, the input vector is renamed according to (Δfov23, Δfov34, Δz2, Δz3, Δbeta2, Δbeta3)=(x1, x2, x3, x4, x5, x6).

The comparison metric model can be designed as a parametric model, as follows:

$$sm = \frac{\begin{matrix}\begin{matrix}a 1 * f 1 ( x 1 , b 1 , … , bi ) + a 2 * f 2 ( x 2 , b 1 , … , bi ) + … + \\ a 6 * f 6 ( x 6 , b 1 , … , bi ) + a 7 * f 7 ( x 2 - x 1 , b 1 , … , bi ) +\end{matrix} \\ a 8 * f 8 ( x 4 - x 3 , b 1 , b 2 , … , bi )\end{matrix}}{a 1 + a 2 + a 3 + a 4 + a 5 + a 6 + a 7 + a 8}$$

a1 . . . a6 are the weighting factors for the influence of the respective configuration parameter.

f1 . . . f6 are non-linear normalization functions of the individual influencing factors and ensure that the influence of the respective influencing factor behaves linearly and lies in the same range of values as the other factors.

b1 . . . bi are any normalization hyperparameters of the respective functions.

The x2−x1 and x4−x3 consider the height offset or the offset in the vertical detection angle between the two neighboring ultrasonic transducers.

In step S13, the comparison metric model specified in this way is parameterized. In order to be able to predict the performance differences from the sensor comparison metric sm, values must be found for the hyperparameters a1 . . . a8, f1 . . . f8 and b1 . . . bi so that the sensor comparison metric always corresponds to the differences in the performance metrics p when transferring the validation data sets between the two configurations under consideration. sm=Δp=p1−p2 with p1 a first performance metric for a first configuration with respect to validation data of a second configuration and p2 a second performance metric of a second configuration with respect to validation data of a first configuration.

The parameterization can be used by classical curve fitting methods e.g. using the least square method.

Alternatively, the comparison metric model can take the form of a data-based model, for example a neural network or a Gaussian process model. This can be trained in a simple way by specifying the configuration feature difference vectors and the associated differences between the performance comparison metrics of the two configurations under consideration, for example according to the following cost function.

$${\sum }_{i , j} {sm}_{i , j} - Δ {p}_{i , j}$$

wherein i and j correspond to the two configurations.

1. A computer-implemented method for training a data-based classification model for a configuration of a new ultrasonic sensor system comprising a plurality of ultrasonic transducers using training data sets, the data-based classification model specifies, for one or more environmental objects, at least one class for an object property, a training data set assigns an input data set from sensor data of the plurality of ultrasonic transducers and/or from sensor data features derived therefrom to a classification vector for one or more environmental objects, the method comprising:
providing training data sets and validation data sets for multiple configurations of measured ultrasonic sensor systems, the training data sets and the validation data sets each comprise, for a measurement situation of a measurement with a relevant configuration, an input data set from sensor data of the plurality of ultrasonic transducers and/or from sensor data characteristics derived therefrom to a classification vector for one or more environmental objects;
selecting one or more of the measured ultrasonic sensor systems, each depending on a sensor comparison metric for a difference between a configuration of the new ultrasonic sensor system and a configuration of the respective measured ultrasonic sensor systems, wherein the respective sensor comparison metric is derived from differences between configuration features of a respective configuration of the new ultrasonic sensor system and a respective measured ultrasonic sensor system according to a comparison metric model provided, which evaluates a comparability of two configurations of ultrasonic sensor systems depending on differences in the configuration features of the configurations under consideration;
selecting training data sets and validation data sets that are assigned to the selected measured ultrasonic sensor systems; and
training the data-based classification model for the configuration of the new ultrasonic sensor system based on the selected training data sets and validation data sets.

2. The method according to claim 1, further comprising:
obtaining further training data sets and further validation data sets for configuring the new ultrasonic sensor system by measurement,
wherein the data-based classification model is trained with the selected training data sets and the selected validation data sets and the further training data sets and further validation data sets.

3. The method according to claim 2, wherein the selection of one or more configurations of measured ultrasonic sensor systems is performed depending on a result of a threshold value comparison of the sensor comparison metric of the respective measured ultrasonic sensor system with respect to the configuration of the new ultrasonic sensor system.

4. The method according to claim 1, wherein:
the comparison metric model is or will be trained as a data-based or parametric model with data sets, and
the data sets each represent differences in the configuration features of configurations of two measured ultrasonic sensor systems to a difference in performance comparison measures of the configurations of the two measured ultrasonic sensor systems in question.

5. The method according to claim 4, wherein:
a classification model is provided for each of the respective measured ultrasonic sensor systems, which is trained with the respectively associated training data sets and validation data sets, and
the performance comparison measure for one of the relevant measured ultrasonic sensor systems is obtained from a validation of the relevant measured ultrasonic sensor system with the validation data of a corresponding other of the two measured ultrasonic sensor systems.

6. The method according to claim 5, wherein:
the validation data sets each comprise measurement situations with variable distances of one or more environmental objects to be classified, and
the performance comparison measure is determined as a function of a minimum distance of the one or more environmental objects to be classified from the ultrasonic sensor system, which is determined as a smallest distance at which proper classification by the relevant classification model of one of the relevant measuring ultrasonic sensor systems is performed using the validation data sets of the relevant other one of the measured ultrasonic sensor systems.

7. The method according to of claim 1, wherein;
the configuration features comprise one or more arrangement features of ultrasonic transducers of a subject ultrasonic sensor system and one or more sensor-type features, and
the configuration features comprise one or more of: one or more interference measures of detection ranges between each of two particular adjacent ultrasonic transducers of the subject ultrasonic sensor system, a mounting height of one or more of the ultrasonic transducers, and a detection angle of the detection range of one or more of the ultrasonic transducers.

8. The method according to claim 1, wherein the classification model is configured as a neural network or as a data-based decision tree.

9. A device, comprising:
a processor configured to perform the method according to claim 1.

10. The method according to claim 1, wherein a computer program product comprises instructions which, when executed by at least one data processing device, cause the at least one data processing device to carry out the method.

11. A non-transitory machine-readable storage medium comprising instructions which, when executed by at least one data processing device, cause the at least one data processing device to carry out the method according to claim 1.
